(19) United States
(12) Patent Application Publication
(10) Pub. No.: US 2023/0044756 A1
(43) Pub. Date: Feb. 9, 2023

(54) RESOURCE DOWNLOAD IN PEER-TO-PEER NETWORKS

(71) Applicant: HEWLETT-PACKARD DEVELOPMENT COMPANY, L.P., Spring, TX (US)

(72) Inventors: Darryl T. Poe, Fort Collins, CO (US); Christoph Graham, Spring, TX (US)

(73) Assignee: HEWLETT-PACKARD DEVELOPMENT COMPANY, L.P., Spring, TX (US)

(21) Appl. No.: 17/794,697

(22) PCT Filed: Jan. 24, 2020
(86) PCT No.: PCT/US2020/015018

§ 371 Date: Jul. 22, 2022

(51) Int. Cl. H04L 67/1074

(52) U.S. Cl. CPC H04L 67/1074

(57) ABSTRACT

In one example in accordance with the present disclosure, a system is described. The system includes a resource splitter to determine a quantity of blocks to divide a resource to be downloaded. A transmitter of the system broadcasts, per block, an identification request through a peer-to-peer network to identify computing devices that have the block. A downloader of the system downloads blocks from other computing devices on the peer-to-peer network. The system also includes an assembler to re-assemble the resource from received blocks.

### BACKGROUND

Computing devices operate using program instructions that, when executed, cause the computing device to carry out any variety of functions. For example, computing devices may run anti-virus program instructions that monitor the computing device for viruses, bugs, or other harmful computing elements.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for downloading resources in a peer-to-peer network, according to an example of the principles described herein.

FIG. 2 is a diagram of a peer-to-peer network for downloading resources, according to an example of the principles described herein.

FIG. 3 is a flow chart of a method for downloading resources in a peer-to-peer network, according to an example of the principles described herein.

FIG. 4 is a flow chart of a method for downloading resources in a peer-to-peer network, according to another example of the principles described herein.

FIG. 5 depicts a non-transitory machine-readable storage medium for downloading resources in a peer-to-peer network, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices operate using program instructions that carry out any variety of functions. For example, computing devices may run anti-virus program instructions that monitor the computing device for viruses, bugs, or other harmful computing elements. In some examples, large networks of similar computing devices may be directed to download and possibly share large files from a content data source. Examples of these large files or “resources” include program instruction updates for tasks like patching, upgrading an application, downloading new instructions or applications, and receiving new or updated virus definition files, or other content.

The computing bandwidth for each computing device to download the resource from the content data source may be a bottleneck to network communications. That is in some cases, each computing device handles the download independently. This may result in high network bandwidth use, high resource usage on the content server, and low performance due to bottlenecks. With large, commonly-shared resources, the original server (or a caching proxy) may provide the same content to all of the computing devices. This may use up a lot of network bandwidth and put a large load on the content server. In a specific example, if each of 1,000 computing devices is to download a 112-megabyte (MB) file from a content data source each night, total traffic may be around 112 gigabytes (GB), which may result in a total download time, for each computing device, of around 90 minutes due to bottlenecks and bandwidth limitations from the content data source.

In another example, an intermediate proxy server on the local network may be used such that content is fetched one time from the external content server. While this may reduce overloading of the content server and its connections, it does not balance the network traffic on the local network, and may create a bottleneck at the new node. This moves the bottleneck “closer to home”. In other words, using the above example, the total traffic is still around 112 GB, which similarly results in bottlenecks and large download times for each computing device on the network. The complications described above are sure to be exacerbated as the size of resources to be downloaded increase and the number of computing devices to which a resource is to be passed increases.

Accordingly, the present specification describes a system for peer-to-peer sharing of resources to be downloaded on a local-area network without relying on a centralized authority system or any special pre-formatting of the download data. Since no single computing device plays a central role, bottlenecks are largely eliminated and bandwidth use is reduced and spread equally over the nodes in the network. In other words, the present specification describes downloading the resource a single time, but distributed as blocks across each of the computing devices on the peer-to-peer network and allowing the computing devices to share the blocks of the resource with one another. Using the above example, the total traffic is 112 MB, which may have a download time of around six seconds.

In other words, the present specification parallelizes the downloading of a resource within a peer-to-peer network and does so without pre-formatting the data in any particular manner or setting it up to work in a particular mode. That is, in some examples resource downloading relies on special setup, managing servers, nodes with special roles, or special data formatting or tagging. Any of these factors can create a bottleneck or suggest extra setup. For example, a centralized tracker or database may keep track of which peers are downloading which pieces so that the peers can coordinate. Such a system implements both a centralized authority and pre-formatting of the data.

The present system by comparison does not include a centralized controller that is keeping track of the operations of different computing devices on the peer-to-peer network. Rather, organization is done online by the peer computing devices themselves. That is, according to the present systems and method, each of the computing devices on a network participate as equal peers, with no designation of a special server and no pre-formatting of the resource to be downloaded. That is, the data may be stored and served with standard formats and transports such as Hypertext Transfer Protocol (HTTP)/HTTP secure (HTTPS).

Accordingly, the present specification describes an environment where the peers provide resource blocks. In a particular example with eight peer computing devices downloading a large file roughly simultaneously, each computing device may download ⅛ of the resource from the content server and will then share their block with other computing devices of the peer-to-peer network such that each computing device ends up with the complete resource. In so doing, the workload is spread equally across the peer-to-peer network.

Accordingly, in general, an upstream resource is downloaded in blocks, in some cases of even size. Each computing device on the peer-to-peer network broadcasts to check to see if any other computing device in the network already has a block, or is busy downloading it, before downloading the block itself. Once all the blocks are present, the particular computing device reassembles the resource and checks a checksum-hash to verify the resource. In this example, this particular computing device is a block supplier to other computing devices until the file is deleted.

Accordingly, the present specification describes a system. The system includes a resource splitter to determine a quantity of blocks to divide a resource to be downloaded into. The system also includes a transmitter to, per block, broadcast an identification request through a peer-to-peer network to identify computing devices that have the block. A downloader of the system downloads blocks from other computing devices on the peer-to-peer network. An assembler of the system re-assembles the resource from received blocks.

The present specification also describes a method. According to the method, a quantity of blocks to split a resource to be downloaded into is determined. This is based on a number of criteria. An identification request is broadcast per block and through a peer-to-peer network to identify computing devices in the peer-to-peer network that have the block. Again per block, a request to download the block is transmitted to an associated computing device on the peer-to-peer network. The resource is then re-assembled from received blocks.

The present specification also describes a non-transitory machine-readable storage medium encoded with instructions executable by a processor. The machine-readable storage medium includes instructions to 1) broadcast a request to determine a quantity of computing devices on a peer-to-peer network and 2) determine a quantity of blocks to split a resource to be downloaded into based on a number of criteria. The machine-readable storage medium also includes instructions to broadcast, per block and through the peer-to-peer network, an identification request to identify computing devices in the peer-to-peer network that have the block. The identification request includes a block identifier and a block size. The machine-readable storage medium also includes instructions to 1) select, per block, from among responding computing devices, a computing device from which each block is to be downloaded and 2) transmit, per block, a request to download the block from a selected computing device. The machine-readable storage medium includes instructions to re-assemble the resource from blocks received from computing devices on the peer-to-peer network and responsive to a request, transmit blocks of the resource located on the computing device.

Such systems and methods 1) reduce network traffic when downloading resources to a large number of computing devices; 2) evenly spread network traffic among the computing devices of a peer-to-peer network; 3) avoid bottlenecks during resource download; 4) eliminate a centralized controller for large batch-type resource downloads; and 5) facilitate resource download without pre-formatting the resource to be downloaded.

As used in the present specification and in the appended claims, the terms “resource splitter,” “downloader,” and “assembler,” may refer to electronic components which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others.

Further, as used in the present specification and in the appended claims, the term “peer-to-peer blocking” or “resource blocking” refers to the division of a resource into sections, or blocks, to be download by different computing devices in a peer-to-peer network. Each computing device may then communicate with other computing devices in the peer-to-peer network to acquire each block and re-assemble the resource from the blocks.

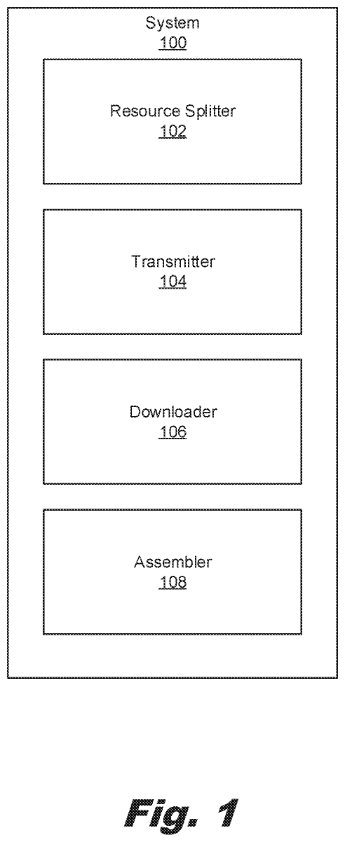

Turning now to the figures, FIG. 1 is a block diagram of a system (100) for downloading resources in a peer-to-peer network, according to an example of the principles described herein. As described above, it may be the case that a particular resource is to be downloaded to a variety of computing devices all on the same network. For example, an organization may deliver an anti-virus update to each computing device on a network. Some organizations are quite large, for example with multiple thousands of computing devices. In this example, and even an example with far fewer computing devices, the amount of time for each computing device to download the full resource from a single site may be quite large and consume enough collective bandwidth that the overall download time is even more greatly increased. As used in the present specification, the term “resource” may refer to any file to be downloaded such as a patch, anti-virus definition file, application update, etc. While particular reference is made to particular resources, the resource may be any file which a computing device, or network of computing devices, wish to download.

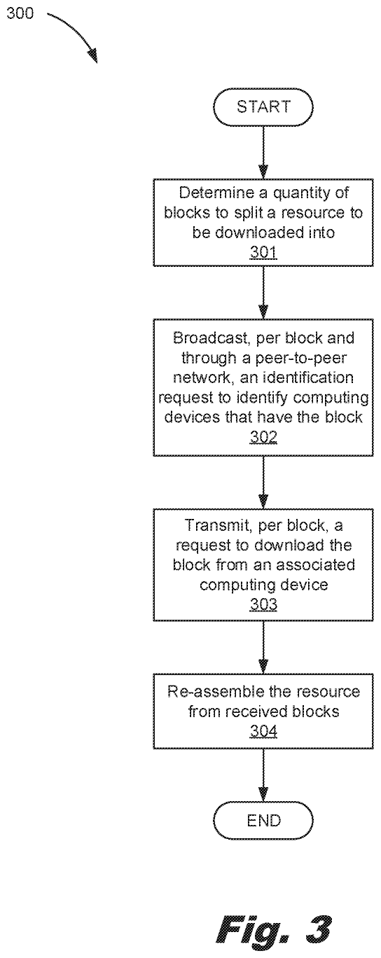

To address what may be large bandwidth bottlenecks, the present system (100), which may be installed on a computing device, divides the resource into blocks and downloads at least some of the blocks of the resource from other computing devices on the peer-to-peer network that may have already downloaded a particular block. Accordingly, the system (100) includes a resource splitter (102) to determine a quantity of blocks to divide a resource to be downloaded into. That is, each block may have a smaller size than the overall resource. The quantity of blocks into which a resource is divided, may be based on any number of criteria. Two particular examples of criteria that define a block quantity include 1) a resource size and 2) a number of computing devices on the peer-to-peer network. For example, if a resource has a file size of 12 MB and there are six computing devices on the peer-to-peer network, the resource may be divided into six blocks, each having a size of 2 MB. While particular reference is made to two specific criteria, determination of block quantities and sizes may be based on other criteria. Examples of additional criteria are described below in connection with FIG. 3.

In some examples, the quantity of blocks that a resource is to be split into may be the same throughout the peer-to-peer network. However, in other examples, the determined quantity of blocks may be different. For example, as described above two examples of criteria upon which resource blocking is determined are file size and quantity of computing devices on the peer-to-peer network. However, there may be other criteria, such as server capability and bandwidth measurements that may change over time. Changes to these criteria over time may alter the size or quantity of blocks that a resource is to be divided into. For example, a resource splitter (102) of a first computing device, at a first period of time may determine to split the resource into 6 blocks, but a resource splitter (102) of a second computing device, at a second period of time, may determine to split the resource into 8 blocks. Notwithstanding the difference in determined block sizes, a particular computing device may still acquire each block according to its own determined block size.

For example, after a first computing device has acquired and re-assembled the entire resource, it could provide a block in accordance with a block size requested by the second computing device from the fully re-assembled resource at the first computing device, notwithstanding that the first computing device may have re-assembled the resource from blocks of different sizes. In the case, that the first computing device requests a block with a first size and a second computing device is downloading a block with a second size, the second computing device can supply the first computing device with a portion of that block that it has downloaded.

In addition to determining the quantity of blocks a resource is to be split into, the system (100) and in some examples the resource splitter (102) may assign a block identifier and note a block size. Such an identifier and size may be designated as an offset into the resource based on the block size. For example, if a block size is determined to be 1 MB, and an identifier for a particular block is 7, this allows the system (100) to identify this block as beginning at beginning at 0+7 MB into the resource.

The system (100) also includes a transmitter (104) to, per block, broadcast an identification request through the peer-to-peer network to identify computing devices that have that block. For example, a resource may be split into eight blocks with identifiers Block0, Block1, Block2, Block3, Block4, Block5, Block6, and Block7. Before downloading each of these blocks from a content server, the transmitter (104) transmits an identification request to other computing devices on the peer-to-peer network to determine if any other computing device has already downloaded that block such that the particular computing device can download blocks from peers, rather than the content server.

Such an identification request may include a variety of pieces of information such as a resource identifier, which may be a combination of a uniform resource locator and its size. In some examples, the identification request includes a resource reference hash. As described below, the resource reference hash provides an error check to ensure that a re-assembled resource matches the resource as it is on the content server.

The identification request may also include a block identifier and a block size such that a computing device receiving the request can determine whether it has the particular block associated with the request. The identification request, in some examples, includes a block reference hash, that similar to the resource reference hash, is used to determine a validity of a received block. In some examples, the identification request does not include a block reference hash, and the validity of the block is rather determined by a consensus of hashes of the blocks as found on the different computing devices.

The downloader (106) of the system (100) downloads blocks from other computing devices on the peer-to-peer network. For example, a second computing device on the peer-to-peer network may indicate it has Block1 and a third computing device on the peer-to-peer network may indicate it has Block2. Accordingly, responsive to receiving this information from the second and third computing devices, the downloader (106) may download Block1 and Block2 from the second and third computing devices respectively. This is repeated until the downloader (106) has acquired each block that is used to form a resource.

The assembler (108) then re-assembles the resource from the received blocks. That is, the assembler (108) can piece together the blocks to re-form the original resource. Accordingly, the system (100) provides that a particular computing device, rather than downloading an entire resource from one location, downloads it from multiple locations in a piece-meal fashion to more evenly distribute the bandwidth consumption across the entire network, thus ensuring a download of the resource in its entirety, but without the bandwidth bottlenecks that would otherwise exist.

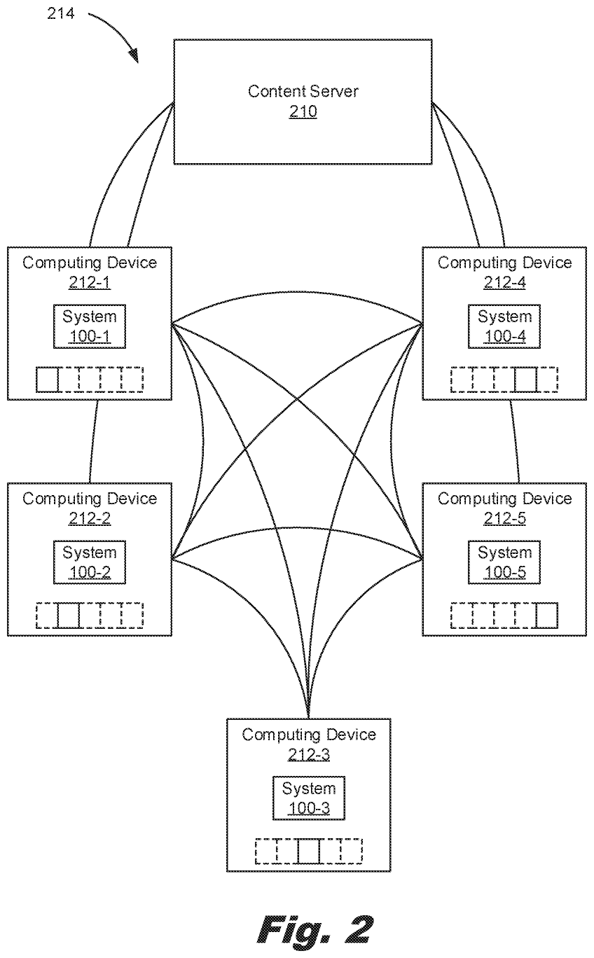

FIG. 2 is a diagram of a peer-to-peer network (214) for downloading resources via peer-to-peer blocking, according to an example of the principles described herein. In the example depicted in FIG. 2, the peer-to-peer network (214) is made up of five computing devices (212-1, 212-2, 212-3, 212-4, 212-5) each having a system (100-1, 100-2, 100-3, 100-4, 100-5) disposed thereon. Each computing device (212) is communicatively coupled to one another and also to a content server (210), such as a local or external server, that contains a resource to be downloaded to the different computing devices (212). As there are five computing devices (212), the resource may be divided into five blocks.

In this example, a first system (100-1) may already have Block0 (as indicated in solid line) and may be searching for Block1, Block2, Block3, and Block4 (as indicated as dashed lines). Accordingly, the transmitter (FIG. 1, 104) of the first system (100-1) sends out a broadcast message, per block, to determine which computing devices (212) contain the respective block. As noted, this may be done sequentially and on a per block basis. That is, the transmitter (FIG. 1, 104) may send an identification request to identify which computing devices (212) have Block1. In this example, the second computing device (212-2) may respond that it has Block1 (as indicated by the solid cube). Accordingly, the downloader (FIG. 1, 106) of the first system (100-1) may download Block1 from the second computing device (212-2). This process may be repeated until the first computing device (212-1) has each block, at which point in time the assembler (FIG. 1, 108) may re-assemble the resource.

While FIG. 2 depicts that each computing device (212) has a single block, it may be the case that multiple computing devices (212) have the block. For example, two computing devices (212) may have Block2. In this example, the first computing device (212-1) may select from which computing device (212) to download Block2. This selection based on a number of selection criteria.

In some examples, this process of requesting and downloading different blocks from different computing device (212) may be occurring simultaneously for the different computing devices (212). Accordingly, it may be the case that a particular computing device (212) responds that it does not actually have a particular block, but is in the process of downloading it. In this case, the computing device (212) that transmitted the identification request may queue the download until it is complete and move on to locate and download another block, or may select another computing device (212) from which to download the requested block

While specific reference is made to computing devices (212) downloading the resource at roughly the same time, synchronous downloads are just one example, and the downloads may be sequential, or all at the same time.

In still further cases, it may be that no responses to the identification request are received. For example, no computing device (212) may have Block5 stored thereon. In this example, the downloader (FIG. 1, 106) downloads the particular block from the content server (210). Downloading from the content server (210) may also happen if the computing device (212) cannot successfully reassemble the resource. In this example, the computing device (212) may download blocks from the content server (210) that it suspects it received as invalid blocks from other computing devices (212) and may continue to do so until the whole resource hash is a match.

Once all blocks are received, the assembler (FIG. 1, 108) may re-assemble the resource. As described above, this may include validating the resource. For example, the assembler (FIG. 1, 108) may compare a hash of the re-assembled resource with a resource reference hash, which may be part of the identification request or otherwise provided to the computing devices (212), to validate the re-assembled resource. That is, the system (100) may include a file it can check to make sure hashes match. If the hashes match, the resource is validated and the download is complete.

When the hash of the re-assembled resource does not match the resource reference hash, the assembler (FIG. 1, 108) may sequentially compare block hashes with block reference hashes to identify invalid blocks. The block reference hash may come from a variety of sources. For example, the block reference hash may be provided as part of the originally available resource, such as a signature file associated with the resource, or could be provided by any of the participating computing devices (212) that have previously computed the block hash.

As another example, each computing device (212) can provide its hash value for the block in question by computing it on the fly from the data it is holding. Accordingly, if the same block hash is received from multiple computing devices and one does not match, the one that does not match may be flagged as an origin of an invalid block.

Once an invalid block is identified, a different location for the block may be identified, it may be downloaded, and the resource re-assembled with the new block. The hash of the re-assembled resource is again compared against the resource reference hash to validate it, thus ensuring that a proper resource is transmitted to the computing device (212), albeit through peers rather than the content server (210).

The origin and identifier of an invalid block may be recorded such that the origin may be ignored if possible, or at least have its priority decreased in subsequent downloads, based on it providing an invalid block.

FIG. 3 is a flow chart of a method (300) for downloading resources in a peer-to-peer network, according to an example of the principles described herein. According to the method (300), a quantity of blocks to split a resource to be downloaded into is determined (block 301) based on a number of criteria. That is, as described above, rather than having each computing device (FIG. 2, 212) individually download the entire resource from a content server (FIG. 2, 210), each computing device (FIG. 2, 212) may download a portion, or block, of the resource, and then each computing device (FIG. 2, 212) may re-assemble the resource from blocks which it receives from other computing devices (FIG. 2, 212) on the peer-to-peer network. In one particular example, each computing device (FIG. 2, 212) downloads a single block from the content server (FIG. 2, 210) and acquires the remaining blocks from other computing devices (FIG. 2, 212) on the peer-to-peer network (FIG. 2, 214).

The criteria on which the split is based may be of a variety of types. One example is the quantity of computing devices (FIG. 2, 212) in the peer-to-peer network (FIG. 2, 214). For example, if there are six computing devices (FIG. 2, 212) in a peer-to-peer network (FIG. 2, 214), the resource may be divided into six blocks. While particular reference is made to the number of blocks equaling the number of computing devices (FIG. 2, 212), other arrangements may also be implemented, for example dividing the resource into N−1 blocks, when there are N computing devices (FIG. 2, 212) on the peer-to-peer network (FIG. 2, 214).

In another example, the determination (block 301) may be based on a quantity of computing devices (FIG. 2, 212) on the peer-to-peer network (FIG. 2, 214) that a requesting computing device (FIG. 2, 212) has communicated with. As yet another example, the criteria may be a quantity of computing devices (FIG. 2, 212) on the peer-to-peer network (FIG. 2, 214) that are in a same set as the requesting computing device (FIG. 2, 212). For example, the resource may be an update to a human resources application running on computing devices (FIG. 2, 212) within the human resources department and there may be five computing devices (FIG. 2, 212) in the human resources department. Accordingly, human resource application update may be split into five blocks.

As another example, the criteria may be a size of the resource. That is, different sizes of resource files may be associated with a corresponding block quantity where each block has a corresponding size. In this example, this resource size may be used to determine (block 301) how many blocks to divide the resource into.

Other examples include a minimum and maximum quantity of blocks. As will be described below, multiple criteria may be used to determine (block 301) how many blocks to split a resource into. In this example, a minimum and/or maximum may be used as a threshold to prevent too many or too few blocks. For example, a resource may be split into blocks based on a quantity of computing devices (FIG. 2, 212). However, if there are 1,000 computing devices (FIG. 2, 212) on a peer-to-peer network (FIG. 2, 214), a maximum quantity of blocks set to 100 may prevent the resource from being split into 1,000 individual blocks.

Another example of a criteria upon which resource blocking is determined is a server capability and another is bandwidth measurements. That is, at different times for a variety of reasons a content server (FIG. 2, 210) may be more capable of handling large downloads. For example, at night, when the content server (FIG. 2, 210) is less busy, other operations may consume less bandwidth, such that more bandwidth may be designated for resource download. In this example, the resource may be divided into fewer blocks. In yet another example, the network configuration itself may be used to determine resource blocking.

In yet another example, a rounding operation may be used to determine (block 301) how many blocks to split a resource into. That is, there may be a subset of available block quantities into which a resource may be split and the determined (block 301) quantity may be one of these particular values. For example, rather than being able to be split into any integer value of blocks, a resource may be divisible into even quantity blocks. This may lead to rounding to the same block quantity each time unless there are changes to the other criteria.

Put another way, if block sizes are partitioned to be a power of two, it may avoid instability that occurs when one peer appears or disappears from the network. This is because the system (FIG. 1, 100) may round to the same block size. As an example, if the resource is 100 MB and to be downloaded by ten peers, an unadjusted block size may be 10 MB each. However, based on rounding, the block size may be rounded up to 16 MB. Accordingly, if the peer-to-peer network (FIG. 2, 214) drops to nine peers, which may result in an unadjusted block size of 11 MB, or rises to 11 peers, which may result in an unadjusted block size of 9 MB, the adjusted block size may still be rounded up to 16 MB and the block size is stable.

While particular reference is made to specific criteria on which a determination (block 301) as to how a resource is to be divided are made, a variety of other criteria may be relied on. Moreover, it should be noted that multiple of the above criteria may be used in combination when determining (block 301) how many blocks a resource should be divided into.

Once this value is determined, the system (FIG. 1, 100) broadcasts (block 302) per block and throughout the peer-to-peer network (FIG. 2, 214), an identification request to identify computing devices (FIG. 2, 212) in the peer-to-peer network (FIG. 2, 214) that have the block. That is, the transmitter (FIG. 1, 104) may, as described above, transmit an identification request for each of the blocks, and may determine from which target computing device (FIG. 2, 212) it is to download that particular block.

Once a particular target computing device (FIG. 2, 212) is identified, the system (FIG. 1, 100) transmits (block 303) a request to download the block from the associated, or target, computing device (FIG. 2, 212) on the peer-to-peer network (FIG. 2, 214). In some examples, this transmission (block 303) is not a broadcast throughout the peer-to-peer network (FIG. 2, 214), but a targeted communication to a particular computing device (FIG. 2, 212). Responsive to this request, the particular computing device (FIG. 2, 212) may send the particular block. This may occur for each block for which a download request is transmitted (block 303), and the requesting computing device (FIG. 2, 212) may re-assemble (block 304) the resource from the received blocks.

In so doing, the requesting computing device (FIG. 2, 212) acquires each block that makes up a resource, albeit from more than just the content server (FIG. 2, 210) and re-assembles (block 304) the resource such that its full form is present on the requesting computing device (FIG. 2, 212).

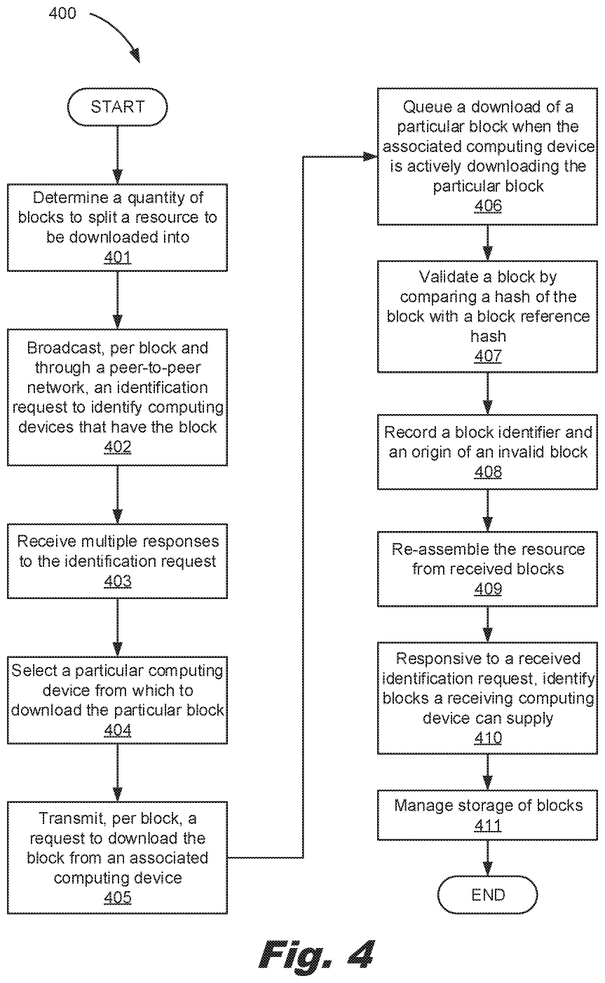

FIG. 4 is a flow chart of a method (400) for downloading resources in a peer-to-peer network, according to another example of the principles described herein.

As described above, the method (400) includes determining (block 401) a quantity of blocks to split a resource to be downloaded into and broadcasting (block 402), per block and through a peer-to-peer network (FIG. 2, 214), an identification request to identify computing devices (FIG. 2, 212) that have the blocks. These operations may be done as described above in connection with FIG. 3.

In some examples, the requesting computing device (FIG. 2, 212) may receive (block 403), for a particular block, multiple responses to the identification request. For example, multiple computing devices (FIG. 2, 212) may indicate that they have Block1 of the resource. In this example, the requesting system (FIG. 1, 100) selects (block 404) a particular computing device (FIG. 2, 212) from which to download the particular block. Such a determination may be based on a number of selection criteria. Note that the selection criteria upon which a particular computing device (FIG. 2, 212) is selected may be different from the criteria related to a determination as to how many blocks to split a resource into.

Examples of different selection criteria are presented. Note that while particular selection criteria examples are described, a variety of selection criteria may be used, either individually or in combination with other selection criteria, to determine where to download a particular block from.

One example is a reliability of a particular computing device (FIG. 2, 212). For example, as described above, invalid blocks may be identified and an origin of the invalid block may be recorded. In this example, the origin, i.e., a particular computing device (FIG. 2, 212), from which an invalid block is received may decrease a likelihood of selecting this particular computing device (FIG. 2, 212) as a source of download of the block.

Another example of selection criterion is a bandwidth of the particular computing devices (FIG. 2, 212). That is, as each computing device (FIG. 2, 212) is different and is actively performing different operations at different times, a bandwidth available to set aside for block download may be different for the different computing devices (FIG. 2, 212) on the peer-to-peer network (FIG. 2, 214). These different bandwidths may be considered when selecting a computing device (FIG. 2, 212) from which to download a particular block, with a computing device (FIG. 2, 212) with a greater bandwidth being more likely to be selected.

Another example is a hash of the block from the particular computing device (FIG. 2, 212) as compared to hashes received from other responding computing devices (FIG. 2, 212). That is, a response to an identification request may include a hash of the particular block. If one of the responses includes a block hash that is different from hashes received from other, i.e., a majority, of the other computing devices (FIG. 2, 212), the computing device (FIG. 2, 212) that is the origin of the different block hash may be de-prioritized in the selection (block 404) operation.

Another example of a selection criterion includes a particular computing device (FIG. 2, 212) status. That is, as with the bandwidth, each computing device (FIG. 2, 212) on a peer-to-peer network (FIG. 2, 214) may have a different status, such as a sleep, active, etc. Such a status may be used to determine whether or not a particular computing device (FIG. 2, 212) is a suitable block source. Yet another example of a selection criterion is a network condition. For example, the system (FIG. 1, 100) may determine that a certain computing device, Device A, has an unusually high dropped-packet rate compared to other peers. In this example, the system (FIG. 1, 100) may treat Device A as a less reliable provider. That is, while Device A provided the block, it may take a while to transmit a large block of data since Device A will have to retransmit all of the dropped packets.

Yet another example is a time of a last request to the particular computing device (FIG. 2, 212). That is, for a number of reasons a particular computing device (FIG. 2, 212) may not have been selected or may not have received an identification request. The length of time since the last of a request or a response to a request may either elevate the likelihood of selection or reduce the likelihood of selection. For example, elevating the likelihood of selection when a particular computing device (FIG. 2, 212) has not had a request for a longer period of time may serve to ensure even distribution of block downloading traffic.

By comparison, it may be the case that a computing device (FIG. 2, 212) that has not responded to a request for a long period of time, or has not received a request for a long period of time, may indicate an issue with that particular computing device (FIG. 2, 212), such that this long period of time may de-prioritize selection of this particular computing device (FIG. 2, 212). Similarly, a short period of time since a last request may either prioritize selection of that computing device (FIG. 2, 212) as that computing device (FIG. 2, 212) may be a reliable source of blocks, or may de-prioritize selection of that computing device (FIG. 2, 212) as that computing device (FIG. 2, 212) may be over-used.

Other examples of selection criteria include a request count of the last request to the particular computing device (FIG. 2, 212), a network response time information from the particular computing device (FIG. 2, 212), and network topology. As a specific example, the system (FIG. 1, 100) may have information indicating that the addresses in a certain range are funneled through a single switch (or network thereof). In this example, the system (FIG. 1, 100) may change the priorities to avoid overloading that switch. In another example, given that network latency is sometimes related to physical distance and to network quality, the system (FIG. 1, 100) may prioritize responses that were received very quickly after a request over those from computing devices that were slow to respond, but that still responded within a response window. As described above, the above-mentioned selection criteria may be used individually or in combination with other selection criteria to determine from which computing device (FIG. 2, 212) a particular block is to be downloaded from.

A request to download the block from a selected computing device (FIG. 2, 212) is then transmitted (block 405). This may be performed as described above in connection with FIG. 3 for each block.

Responsive to such a transmission (block 405), the system (FIG. 1, 100) may download the particular block from the selected computing device (FIG. 2, 212). In some examples however, the selected computing device (FIG. 2, 212) may be busy downloading that particular block. In this example, based on a response that the particular computing device (FIG. 2, 212) is actively downloading a particular block, the system (FIG. 1, 100) may queue (block 406) a download of the particular block from the particular computing device (FIG. 2, 212). In this example, the download may be queued (block 406) for a predetermined period of time, or for a period of time identified by the selected computing device (FIG. 2, 212).

In some examples, the received block may be validated (block 407) by comparing a hash of the block with a block reference hash. As described above, in some examples the block hash comparison may occur once it has been determined, based on a resource hash comparison, that a resource is faulty. For example, if a resource hash does not match a resource reference hash, the system (FIG. 1, 100) can begin a process of elimination to determine which block was faulty.

In the example described here, the validation of the block may be performed before the resource hash comparison. That is, the validation of the block may occur as the block is received. If the system (FIG. 1, 100) finds a faulty block, it may record (block 408) a block identifier and an origin of any invalid block. Following this recordation (block 408), the computing device (FIG. 2, 212) may inform the peer of potential corruption, ignore that peer in the future or perhaps give it lowest priority when selecting between block offers.

As described above, the system (FIG. 1, 100) may then re-assemble (block 408) the resource from received blocks, which may be performed as described above in connection with FIG. 3.

As described above, each computing device (FIG. 2, 212) is requesting blocks and responding to requests from other computing devices (FIG. 2, 212) for blocks. Accordingly, the system (FIG. 1,100), responsive to received identification requests, may identify (block 410) whether a receiving computing device (FIG. 2, 212) can supply a block. Thus, a network is provided which allows for the provision of blocks of a resource from the collective peer-to-peer network (FIG. 2, 214), without relying on the content server (FIG. 2, 210) to provide the whole resource to each of the computing devices (FIG. 2, 212) on the peer-to-peer network (FIG. 2, 214).

Once the resources are re-assembled, the method (400) includes managing (block 411) storage of block identifiers and blocks associated with the resource. The management (block 411) of the block-related information may be based on predetermined criteria. For example, block-related information may be deleted based on predetermined schedule or based on available memory, etc.

In some examples, the system (FIG. 1, 100) may decide whether and when to cache data for the purpose of supplying blocks to peers on its network. Criteria for the retention and disposing of cache may include the amount of free space on the system, age of the data in question, last received request for that data, etc.

In some specific examples, the system (FIG. 1, 100) may use heuristics to tune the retention of data depending on the amount of peer-to-peer traffic active on the network (FIG. 2, 214), historical data, disk space use on the system, memory use on the system, system load, time thresholds, and other factors. As an extension, the system (FIG. 1, 100) may utilize otherwise-unused memory or disk space to retain block data and release the otherwise-unused memory back to the system (FIG. 1, 100) as soon as there is demand for those resources, thereby utilizing resources that are otherwise sitting idle.

An overall example of the operation of a first system (FIG. 1, 100-1) is now presented, which system operates on computing devices (FIG. 2, 212) a local-area network (FIG. 2, 214) containing a large number of similar computing devices (FIG. 2, 212). As described above, a similar operation may be occurring for each of the systems (FIG. 1, 100) in the peer-to-peer network (FIG. 2, 214).

As described above, when a first system (FIG. 1, 100-1) starts, it sends a broadcast, such as a User Datagram Protocol (UDP) packet to the local-area network (FIG. 2, 214), which broadcast requests responses from peers running the same protocol, so that the first system (FIG. 1, 100-1) can get a preliminary count of peers and advertise its presence as a potential peer.

When the first system (FIG. 1, 100-1) begins the process of downloading a resource from a network site such as an HTTP server, it obtains the size of the resource, and in some cases, a cryptographic hash of the resource's contents for error-checking. The first system (FIG. 1, 100-1) then decides to break the download of the resource into a set of contiguous blocks of binary data. As described above, the number and size of those blocks may be based on the size of the original resource, the number of peers the first system (FIG. 1, 100-1) has discovered, the number of peers the first system (FIG. 1, 100-1) has talked to historically, minimum and maximum numbers of blocks, server capabilities, historical bandwidth measurements, network configuration, or other factors.

For each block, the first system (FIG. 1, 100-1) broadcasts a UDP message requesting that block. The original uniform resource identifier (URI) of the resource and/or a hash of that URI, along with a block number and block size, will be used as a unique identifier for each block the first system (FIG. 1, 100-1) seeks to obtain.

Any peer on the network (FIG. 2, 214) that can supply the one of the requested blocks will respond with a UDP message directly to the first system (FIG. 1, 100-1). The first system (FIG. 1, 100-1) may look through the set of responses and choose one peer to send a specific block request to. As described above, the selection may be based on a variety of factors, including whether the block has been verified to be part of a whole file matching the original asset hash, the system load or network load factor of the peer, whether the peer has finished downloading the block or whether it is still in progress, the latency or bandwidth available to that peer based on historical data, the reliability of answers from that peer based on historical data, the roundtrip or time to live (TTL) measurement of returned responses from peers, whether there is a consensus on the block hash value, etc.

If the first system (FIG. 1, 100-1) does not receive responses to its identification request broadcast, the first system (FIG. 1, 100-1) may begin downloading the block from the content server (FIG. 2, 210), making that data available to other peers on the network (FIG. 2, 214). Once a block has been downloaded, a hash of its data can be generated and passed around as an additional check on its fidelity after a download. If a system (FIG. 1, 100) is busy downloading a particular block, it can relay that information to other systems (FIG. 1, 100) requesting the same block, and it can tell the other requesting systems (FIG. 1, 100) when it is finished.

In some examples, the first system (FIG. 1, 100-1) requests each block sequentially, skipping over blocks that other systems (FIG. 1, 100) are in the process of downloading. This may increase parallelism within the network (FIG. 2, 214). If several systems (FIG. 1, 100) start a download at roughly the same time, the first system (FIG. 1, 100-1) may download the first block. The second system (FIG. 1, 100-2) may ask for the first block and will find out that the first system (FIG. 1, 100-1) is busy downloading it, so it will check for the second block. Since no system (FIG. 1, 100) responds for the second block, the second system (FIG. 1, 100-2) may download the second block. Similarly, the third system (FIG. 1, 100-3) may find that first and second blocks are “in progress” of being downloaded and may download the third block. Once each system (FIG. 1, 100) has downloaded its share of the total, the systems (FIG. 1, 100) may start sharing among themselves. With good selection criteria, this spreads the processor load and network traffic evenly across the computing devices (FIG. 2, 212) on the network (FIG. 2, 214), and each block is downloaded once from the content server (FIG. 2, 210).

Once all of the blocks are present locally—whether they came from direct download from the content server (FIG. 2, 210) or from a peer—the first system (FIG. 1, 100-1) may re-assemble the resource from received blocks. After reassembly, the first system (FIG. 1, 100-1) may check the hash of the resource against the resource reference hash from the content server (FIG. 2, 210). If the hash matches, the first system (FIG. 1, 100-1) may be sure that the resource download was successful and accurate and, furthermore, that the data in any particular block of that resource was trustworthy.

If the hash does not match, the first system (FIG. 1, 100-1) can begin a process of elimination to determine which block was faulty. If it finds a faulty block, the first system (FIG. 1, 100-1) may record the origin of that block so that it can inform the peer of potential corruption, ignore that peer in the future, or perhaps give it lowest priority when selecting between block offers.

Once a resource has been reassembled, the first system (FIG. 1, 100-1) may discard the individual blocks, or it may wish to retain them for a period of time to benefit and seed the other peers on the network (FIG. 2, 214). As long as the file remains on the computing device (FIG. 2, 212) and its hash remains a match, the first system (FIG. 1, 100-1) on that computing device (FIG. 2, 212) may always regenerate a block by pulling select bytes directly from the locally-stored resource.

Note that in the environment, each computing device (FIG. 2, 212) is requesting blocks from other computing devices (FIG. 2, 212) and also providing blocks of resource. That is, each computing device (FIG. 2, 212) transmits identification requests and downloads blocks and also responds to identification requests and uploads blocks.

In some examples, if the resource or network configuration deem it appropriate, the communications between peers may be encrypted using any variety of encryption protocols.

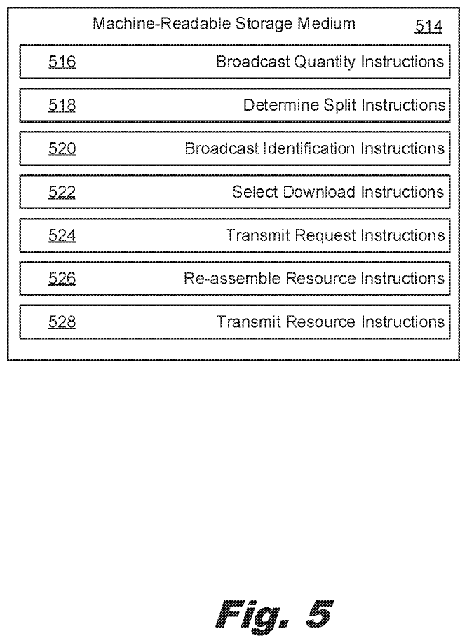

FIG. 5 depicts a non-transitory machine-readable storage medium (514) for downloading resources in a peer-to-peer network, according to an example of the principles described herein. To achieve its desired functionality, a computing system includes various hardware components. Specifically, a computing system includes a processor and a machine-readable storage medium (514). The machine-readable storage medium (514) is communicatively coupled to the processor. The machine-readable storage medium (514) includes a number of instructions (516, 518, 520, 522, 524, 526, 528) for performing a designated function. The machine-readable storage medium (514) causes the processor to execute the designated function of the instructions (516, 518, 520, 522, 524, 526, 528).

Referring to FIG. 5, broadcast quantity instructions (516), when executed by the processor, cause the processor to broadcast a request to determine a quantity of computing devices (FIG. 2, 212) on a peer-to-peer network (FIG. 2, 214). In a specific example, Internet protocol version 4 (IPV4) UDP broadcast packets may be transmitted. Since IPV4 UDP broadcast packets do not cross subnet boundaries, the set of peers may be defined by its subnet. If an organization desires to widen the potential pool of peers, it could set up a mechanism to forward broadcast messages from this protocol from one subnet to another, using a node that lives and can listen to both networks. If the environment supports some minor shared configuration, a list of machines could be supplied, one per subnet, and each of those machines could do forwarding on behalf of their own subnet. In an Internet protocol version 6 (IPV6) environment, a multicast address can be used instead of UDP broadcast.

Determine split instructions (518), when executed by the processor, may cause the processor to, determine a quantity of blocks to split a resource to be downloaded into based on a number of criteria. Broadcast identification instructions (520), when executed by the processor, may cause the processor to broadcast, per block and through the peer-to-peer network (FIG. 2, 214), an identification request to identify computing devices (FIG. 2, 212) in the peer-to-peer network (FIG. 2, 214) that have the block. In this example, the identification request includes a block identifier and a block size.

Select download instructions (522), when executed by the processor, may cause the processor to select, per block, from among responding computing devices (FIG. 2, 212), a computing device (FIG. 2, 212) from which each block is to be downloaded. Transmit request instructions (524), when executed by the processor, may cause the processor to transmit, per block, a request to download the block from a selected computing device (FIG. 2, 212). Re-assemble resource instructions (526), when executed by the processor, may cause the processor to re-assemble the resource from blocks received from computing devices (FIG. 2, 212) on the peer-to-peer network (FIG. 2, 214). Transmit resource instructions (528), when executed by the processor, may cause the processor to responsive to a request, transmit blocks of the resource located on the computing device (FIG. 2, 212).

Such systems and methods 1) reduce network traffic when downloading resources to a large number of computing devices; 2) evenly spread network traffic among the computing devices of a peer-to-peer network; 3) avoid bottlenecks during resource download; 4) eliminate a centralized controller for large batch-type resource downloads; and 5) facilitate resource download without pre-formatting the resource to be downloaded.

What is claimed is:

1. A system, comprising:
a resource splitter to determine a quantity of blocks to divide a resource to be downloaded into;
a transmitter to, per block, broadcast an identification request through a peer-to-peer network to identify computing devices that have the block;
a downloader to download blocks from other computing devices on the peer-to-peer network; and
an assembler to re-assemble the resource from received blocks.

2. The system of claim 1, wherein the identification request comprises at least one of:
a resource identifier;
a block identifier;
a block size;
a resource reference hash; and
a block reference hash.

3. The system of claim 1, wherein the assembler is to compare a hash of a re-assembled resource with a resource reference hash to validate a re-assembled source.

4. The system of claim 3, wherein, when the hash of the re-assembled resource does not match the resource reference hash, the assembler is to sequentially compare block hashes with block reference hashes to identify invalid blocks.

5. The system of claim 1, wherein the downloader is to download the particular block from a server.

6. A method, comprising:
determining a quantity of blocks to split a resource to be downloaded into based on a number of criteria;
broadcasting, per block and through a peer-to-peer network, an identification request to identify computing devices in the peer-to-peer network that have the block;
transmitting, per block, a request to download the block from an associated computing device on the peer-to-peer network; and
re-assembling the resource from received blocks.

7. The method of claim 6, further comprising, responsive to receiving an identification request, identifying whether a receiving computing device has an associated block.

8. The method of claim 6, wherein the number of criteria are selected from the group consisting of:
a quantity of computing devices in the peer-to-peer network;
a quantity of computing devices in the peer-to-peer network that a requesting computing device has communicated with;
a size of the resource;
a minimum quantity of blocks;
a maximum quantity of blocks;
a server capability;
bandwidth measurements;
a network configuration; and
a rounding operation.

9. The method of claim 6, further comprising:
receiving, for a particular block, multiple responses to the identification request; and
selecting, based on a number of selection criteria, a particular computing device from which to download the particular block.

10. The method of claim 9, wherein the selection criteria are selected from the group consisting of:
particular computing device reliability;
particular computing device bandwidth;
a hash of the block from the particular computing device as compared to hashes received from other responding computing devices;
particular computing device status;
network conditions;
a time of last request to the particular computing device;
a request count of the last request to the particular computing device;
network response time information from the particular computing device; and
network topology.

11. The method of claim 6, further comprising validating a block by comparing a hash of the block with a block reference hash.

12. The method of claim 6, further comprising, based on a response that a particular computing device is actively downloading a particular block, queue a download of the particular block from the particular computing device.

13. The method of claim 6, further comprising recording a block identifier and an origin of any invalid block.

14. A non-transitory machine-readable storage medium encoded with instructions executable by a processor, the machine-readable storage medium comprising instructions to:
broadcast a request to determine a quantity of computing devices on a peer-to-peer network;
determine a quantity of blocks to split a resource to be downloaded into based on a number of criteria;
broadcast, per block and through the peer-to-peer network, an identification request to identify computing devices in the peer-to-peer network that have the block, wherein the identification request comprises a block identifier and a block size;
select, per block, from among responding computing devices, a computing device from which each block is to be downloaded;
transmit, per block, a request to download the block from a selected computing device;
re-assemble the resource from blocks received from computing devices on the peer-to-peer network; and
responsive to a request, transmit blocks of the resource located on the computing device.

15. The non-transitory machine-readable storage medium of claim 14, further comprising instructions to manage storage of block identifiers associated with the resource based on predetermined criteria.
